(19) United States
(12) Patent Application Publication
(10) Pub. No.: US 2026/0113283 A1
(43) Pub. Date: Apr. 23, 2026

(54) COMMUNICATION APPARATUS, COMMUNICATION METHOD AND PROGRAM

(71) Applicant: NTT, Inc., Tokyo (JP)

(72) Inventors: Takahiro SUZUKI, Musashino-shi (JP); Sang-Yuep KIM, Musashino-shi (JP)

(73) Assignee: NTT, Inc., Tokyo (JP)

(21) Appl. No.: 19/117,326

(22) PCT Filed: Oct. 27, 2022
(86) PCT No.: PCT/JP2022/040151

§ 371 Date: Mar. 31, 2025

(51) Int. Cl. H04L 47/70; H04L 47/43

(52) U.S. Cl. CPC H04L 47/70; H04L 47/43

(57) ABSTRACT

A communication device on a transmission side includes: a combination part which combines a plurality of pieces of transmission data; a transmission part which transmits an internal signal based on the plurality of pieces of combined transmission data for each interrupt processing or polling processing; and a distribution part which distributes an external signal based on the transmitted internal signal to a plurality of transmission ports. A communication device on a reception side includes: a combination part which combines a plurality of external signals input to a plurality of reception ports; a reception part which acquires an internal signal based on the plurality of combined external signals for each interrupt processing or polling processing; and a distribution part which distributes a piece of reception data based on the acquired internal signal to a plurality of data processing parts.

### TECHNICAL FIELD

The present invention relates to a communication device, a communication method, and a program.

### BACKGROUND ART

There is a communication device which communicates signals for each port. FIG. 7 is a diagram showing a configuration example of a communication system 10. The communication system 10 includes a transmission-side communication device 11-1 and a reception-side communication device 11-2. A communication device 11 is, for example, a server device.

The communication device 11 includes a data processing device 12 and a transfer device 13. The data processing device 12 is a processor. The data processing device 12 includes a data processing part 121 for each port 132. The data processing device 12 includes a communication part 122 (thread) for each of the ports 132. The data processing device 12 includes a memory (not shown) which is shared in a plurality of communication parts 122 in communication processing. The transfer device 13 is a data transfer board (for example, a network interface card (NIC)). The transfer device 13 includes a buffer 131 for each of the ports 132.

The communication device 11 performs packet processing using, for example, a data plane development kit (DPDK) (refer to NPD 1). The communication device 11-1 transmits a signal to the communication device 11-2 for each of the ports 132.

In the transmission-side communication device 11-1, the data processing part 121-1 performs predetermined data processing on the transmission data for each port 132-1. The communication part 122-1 outputs frames including transmission data to a buffer 131-1 for each port 132-1. The frame is, for example, an Ethernet (registered trademark) frame. The buffer 131-1 stores frames for each of the ports 132-1. The buffer 131-1 transmits a frame-based signal (packet) to the port 132-1. The port 132-1 transfers the signal to the port 132-2 connected to the port 132-1.

In the communication device 11-2 on the reception side, the port 132-2 transfers the frame based on the signal (packet) transferred from the port 132-1 to the buffer 131-2 connected to the port 132-2. The buffer 131-2 stores frames transferred from the port 132-2. The buffer 131-2 transfers frames to the communication part 122-2 for each of the ports 132-2. The communication part 122-2 acquires reception data from the frame. The communication part 122-2 outputs reception data to the data processing part 121-2 for each of the ports 132-2. The data processing part 121-2 performs predetermined data processing on reception data for each of the ports 132-2.

### CITATION LIST

### Non Patent Document

NPD 1: I. Cerrato, M. Annarumma and F. Risso, “Supporting Fine-Grained Network Functions through Intel DPDK, ” 2014 Third European Workshop on Software Defined Networks, 2014, pp. 1-6, doi: 10.1109/EWSDN. 2014.33.

### SUMMARY OF INVENTION

### Technical Problem

However, in such a communication system 10, the number of communication parts 122 (threads) increases as the number of ports 132 through which signals are input and output increases. Also, as the number of communication parts 122 increases, the load of data communication processing (transmission processing and reception processing) in the communication part 122 increases.

Here, since a plurality of communication parts 122 access the shared memory (not shown) of the data processing device 12 (processor), the frequency of access to the shared memory increases as the number of communication parts 122 increases. The higher the frequency of access, the more conflict in access timing occurs, which increases the load on communication processing. Furthermore, even when one communication part 122 performs communication processing for each port 132 (sequential execution), the load of communication processing increases as the number of communication parts 122 increases.

When the number of signal ports increases as described above, there is a problem in that it is not possible to suppress an increase in communication processing load.

In view of the above circumstances, an object of the present invention is to provide a communication device, a communication method, and a program in which an increase in communication processing load can be suppressed even when the number of signal ports increases.

### Solution to Problem

An aspect of the present invention is a communication device including: a combination part which combines a plurality of pieces of transmission data; a transmission part which transmits an internal signal based on the plurality of pieces of combined transmission data for each interrupt processing or polling processing; and a distribution part which distributes an external signal based on the transmitted internal signal to a plurality of transmission ports.

An aspect of the present invention is a communication device including: a combination part which combines a plurality of external signals input to a plurality of reception ports; a reception part which acquires an internal signal based on the plurality of combined external signals for each interrupt processing or polling processing; and a distribution part which distributes a piece of reception data based on the acquired internal signal to a plurality of data processing parts.

An aspect of the present invention is a communication method performed by a communication device including: a step of combining a plurality of pieces of transmission data; a step of transmitting an internal signal based on the plurality of pieces of combined transmission data for each interrupt processing or polling processing; and a step of distributing an external signal based on the transmitted internal signal to a plurality of transmission ports.

An aspect of the present invention is a communication method performed by a communication device including: a step of combining a plurality of external signals input to a plurality of reception ports; a step of acquiring an internal signal based on the plurality of combined external signals for each interrupt processing or polling processing; and a step of distributing a piece of reception data based on the acquired internal signal to a plurality of data processing parts.

An aspect of the present invention is a program causing a computer to execute: a procedure of combining a plurality of pieces of transmission data; a procedure of transmitting an internal signal based on the plurality of pieces of combined transmission data for each interrupt processing or polling processing; and a procedure of distributing an external signal based on the transmitted internal signal to a plurality of transmission ports.

An aspect of the present invention is a program causing a computer to execute: a procedure of combining a plurality of external signals input to a plurality of reception ports; a procedure of acquiring an internal signal based on the plurality of combined external signals for each interrupt processing or polling processing; and a procedure of distributing a piece of reception data based on the acquired internal signal to a plurality of data processing parts.

### Advantageous Effects of Invention

According to the present invention, even when the number of signal ports increases, it is possible to suppress an increase in communication processing load.

### BRIEF DESCRIPTION OF DRAWINGS

FIG. 1 A diagram showing a configuration example of a communication system in a first embodiment.

FIG. 2 A diagram showing an example of an operation of a communication device on a transmission side in the first embodiment.

FIG. 3 A diagram showing an example of an operation of a communication device on a reception side in the first embodiment.

FIG. 4 A diagram showing a configuration example of a communication system in a second embodiment.

FIG. 5 A diagram showing a configuration example of a communication system in a third embodiment.

FIG. 6 A diagram showing an example of a hardware configuration of a communication device in each embodiment.

FIG. 7 A diagram showing a configuration example of a communication system.

### DESCRIPTION OF EMBODIMENTS

Embodiments of the present invention will be described in detail with reference to the drawings.

### First Embodiment

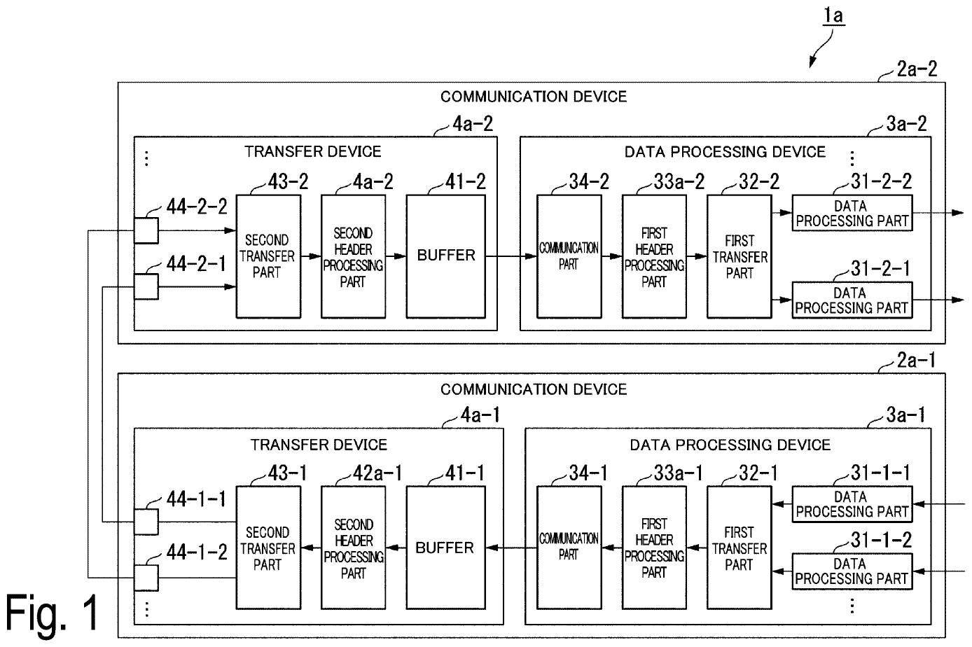

FIG. 1 is a diagram showing a configuration example of a communication system 1a in a first embodiment. The communication system 1a includes a transmission-side communication device 2a-1 and a reception-side communication device 2a-2. A communication device 2a is, for example, a server device. The communication device 2a-1 is connected to the communication device 2a-2 on a reception side using point-to-point (P2P).

The communication device 2a includes a data processing device 3a and a transfer device 4a. The data processing device 3a is, for example, a processor. The data processing device 3a may include hardware such as an accelerator. The data processing device 3a includes a data processing part 31 for each port 44. Also, the data processing device 3a includes a first transfer part 32, a first header processing part 33a, and a communication part 34.

The data processing device 3a includes a memory (not shown) used for communication processing (delivery processing) by the communication part 34.

The transfer device 4a is a data transfer board (for example, a network interface card). The transfer device 4a includes a buffer 41, a second header processing part 42a, a second transfer part 43, and the plurality of ports 44.

The communication device 2a performs packet processing using, for example, a data plane development kit (DPDK). The communication device 2a-1 transmits a signal (packet) to the communication device 2a-2 for each of the ports 44.

Details of the transmission-side communication device 2a-1 (transmitting device) will be explained below.

The data processing part 31-1 performs predetermined data processing on the transmission data for each of the ports 44-1. The first transfer part 32-1 (combination processing part on the transmission side) combines the transmission data which has been subjected to predetermined data processing by the plurality of data processing parts 31-1. The first transfer part 32-1 transfers the frame (signal) including the combined transmission data to the first header processing part 33a-1. The frame is, for example, an Ethernet (registered trademark) frame.

The first header processing part 33a-1 (header addition part on the transmission-side) adds header information to the frame. The header information includes information representing the number of ports 44-1 (number of ports) used for transferring signals (packets) based on the frame, a buffer length of the frame, and a type of data processing of the frame.

The communication part 34-1 (transmission part) records frames to which header information is added in the buffer 41-1 by performing communication processing (delivery processing) for each interrupt processing or polling processing. Note that, between the buffer 41-1 and the communication part 34-1, the communication processing load (amount of communication processing) performed for each interrupt processing or polling processing for frame delivery does not depend on the length of the transmission data included in the frame.

The buffer 41-1 (buffer on the transmission side) stores frames to which header information is added every time the communication part 34-2 performs interrupt processing or polling processing. The second header processing part 42a-1 (header analysis part on the transmission side) analyzes header information added to the frame. The second header processing part 42a-1 acquires information representing the number of transmission ports (ports 44-1) used for signal transfer (transmission) (hereinafter referred to as “first number information”) from the header information. The second header processing part 42a-1 outputs the first number information to the second transfer part 43-1.

The second transfer part 43-1 (distribution processing part on the transmission side) transfers the frame (signal) to which header information is added to one or more ports 44-1 used for signal transfer. Here, the second transfer part 43-1 distributes signals (packets) based on frames to which header information is added to the ports 44-1 of the number represented by the first number information. The port 44-1 transfers the distributed signals to the port 44-2.

Details of the reception-side communication device 2a-2 (reception device) will be explained below.

A signal (packet) is input to the port 44-2 from the port 44-1. The port 44-2 transfers the signal to a second transfer part 43-2. The second transfer part 43-2 (combination processing part on the reception side) combines the transferred signals. The second transfer part 43-2 transfers the frame based on the combined signal to the second header processing part 42a-2. The second transfer part 43-2 transfers the frame based on the combined signal to the second header processing part 42a-2.

The second header processing part 42a-2 (header addition part on the reception side) adds header information to the frame based on the signal. The header information includes information representing the number of ports 44-2 used for signal transfer (number of ports), a buffer length of the frame, and a type of data processing of the frame. The buffer 41-2 (buffer on the reception side) stores frames to which header information is added.

The communication part 34-2 (reception part) acquires frames to which header information is added from the buffer 41-2 by performing communication processing (delivery processing) for each interrupt processing or polling processing. Note that, between the buffer 41-2 and the communication part 34-2, the communication processing load (amount of communication processing) performed for each interrupt processing or polling processing for frame delivery does not depend on the length of the received data included in the frame.

The first header processing part 33a-2 (header analysis part on the reception side) analyzes header information added to the frame. The first header processing part 33a-2 acquires information representing the number of reception ports (ports 44-2) used for signal transfer (reception) (hereinafter referred to as “second number information”) from the header information. The first header processing part 33a-2 outputs the second number information to the first transfer part 32-2. The first transfer part 32-2 (distribution processing part on the reception side) transfers the reception data to the number of data processing parts 31-2 represented by the second number information on the basis of the header information.

The data processing part 31-2 performs predetermined data processing on the reception data transferred from the first transfer part 32-2. Here, the data processing part 31-2 may perform different data processing for each of the ports 44-2.

An example of an operation of the communication system 1a will be explained below.

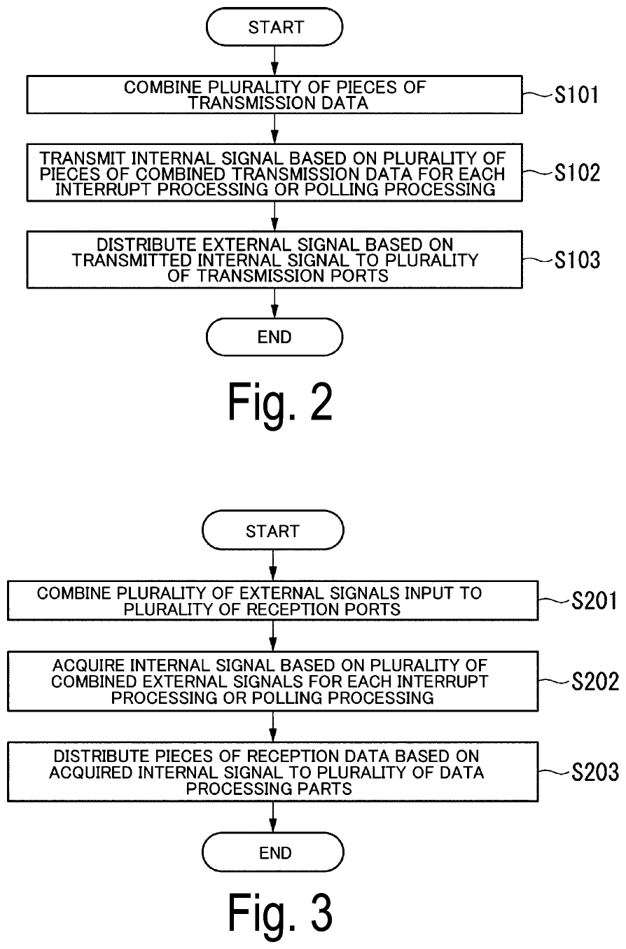

FIG. 2 is a diagram showing an example of an operation of a transmission-side communication device 2a-1 in the first embodiment. The first transfer part 32-1 combines a plurality of pieces of transmission data output from the plurality of data processing parts 31-1 (Step S101). The communication part 34-1 transmits an internal signal based on the plurality of pieces of combined transmission data to the transfer device 4a-1 for each interrupt process or polling process (Step S102). The second transfer part 43-1 distributes external signals based on the transmission internal signals to a plurality of ports 44 (transmission ports) (Step S103).

FIG. 3 is a diagram showing an example of an operation of the communication device 2a-2 on the reception side in the first embodiment. The second transfer part 43-2 combines a plurality of external signals input to the plurality of ports 44 (reception ports) (Step S201). The communication part 34-2 acquires an internal signal based on a plurality of combined external signals from the transfer device 4a-2 for each interrupt process or polling process (Step S202). The first transfer part 32-2 distributes a piece of reception data based on the acquired internal signal to the plurality of data processing parts 31-2 (Step S203).

As described above, in the communication device 2a-1 (transmission device), the first transfer part 32-1 (combination part in the transmission device) combines a plurality of pieces of transmission data output from a plurality of data processing parts 31-1. The communication part 34-1 (transmission part) transmits an internal signal (frame) based on a plurality of pieces of combined transmission data for each interrupt processing or polling processing. The second transfer part 43-1 (distribution part in the transmission device) distributes external signals (packets) based on the transmitted internal signal to the plurality of ports 44 (transmission ports).

Also, in the communication device 2a-2 (reception device), the second transfer part 43-2 (combination part in the reception device) combines a plurality of external signals input to the plurality of ports 44 (reception ports).

The communication part 34-2 (reception part) acquires an internal signal based on a plurality of combined external signals from the transfer device 4a-2 for each interrupt processing or polling processing. The first transfer part 32-2 (distribution part in the reception device) distributes a piece of reception data based on the acquired internal signal to the plurality of data processing parts 31-2.

Thus, even when the number of signal ports 44 increases, it is possible to suppress an increase in communication processing load. Furthermore, since an increase in communication processing load is suppressed, data transfer with low delay and high throughput is possible.

Note that, when the data processing device 3a includes a plurality of communication parts 34, that is, when the processor starts a plurality of threads for data communication processing (delivery processing), since a plurality of communication parts 34 (threads) access the shared memory of the data processing device 3a, the frequency of access to the shared memory increases as the number of communication parts 34 increases. The higher the frequency of access, the more conflict in access timing occurs, which increases the load on communication processing.

The load of communication processing using such a plurality of communication parts 34-1 is larger than the sum of the load of combining processing in the first transfer part 32-1 and the load of distribution processing in the second transfer part 43-1. Similarly, the communication processing load using the plurality of communication parts 34-2 is larger than the sum of the combination processing load on the second transfer part 43-2 and the distribution processing load on the first transfer part 32-2.

In the communication system 1a, there is not a plurality of communication parts 34-1 and there is not a plurality of communication parts 34-2. Instead, a combination process and a distribution process with a small load are performed. For this reason, even when the number of signal ports 44 increases, it is possible to suppress an increase in communication processing load.

### Second Embodiment

A main difference between a second embodiment and the first embodiment is that the communication device on the reception side includes a detection part which detects signal input. In the second embodiment, differences between the first embodiment and the second embodiment will be mainly explained.

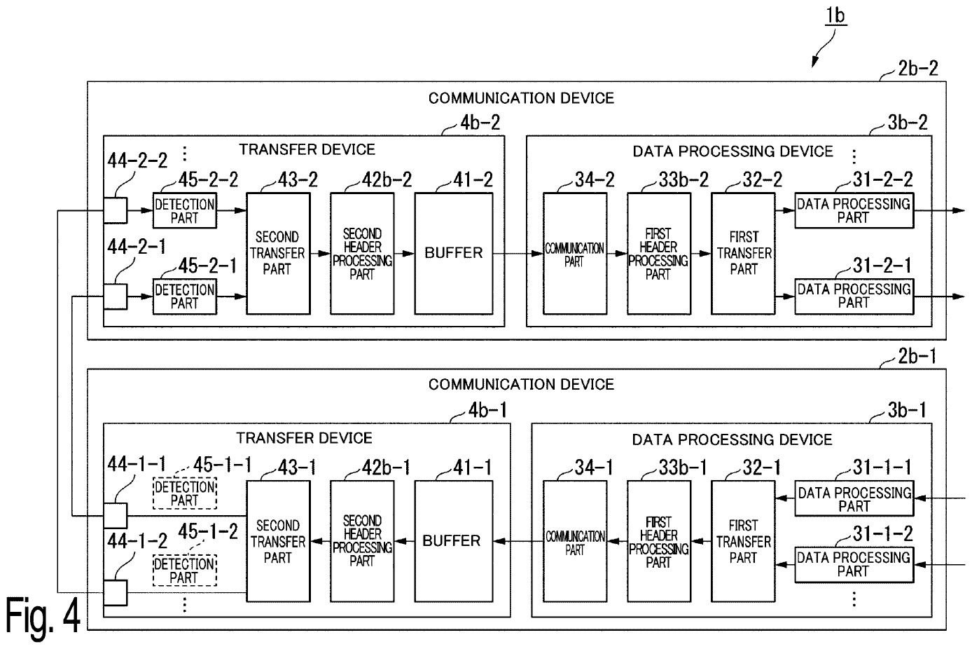

FIG. 4 is a diagram showing a configuration example of a communication system 1b in the second embodiment. The communication system 1b includes a transmission-side communication device 2b-1 and a reception-side communication device 2b-2. A communication device 2b is, for example, a server device. The communication device 2b-1 is connected to the communication device 2b-2 on a reception side using point-to-point.

The communication device 2b includes a data processing device 3b and a transfer device 4b. The data processing device 3b is, for example, a processor. The data processing device 3b may include hardware such as an accelerator. The data processing device 3b includes a data processing part 31 for each port 44. Also, the data processing device 3b includes a first transfer part 32, a first header processing part 33b, and a communication part 34. The data processing device 3b includes a memory (not shown) used for communication processing by the communication part 34.

A transfer device 4b is a data transfer board (for example, a network interface card). A transmission-side transfer device 4b-1 includes a buffer 41, a second header processing part 42b, a second transfer part 43, and the plurality of ports 44. The reception-side transfer device 4b-2 includes a buffer 41, a second header processing part 42b, a second transfer part 43, and the plurality of ports 44. Also, the transfer device 4b-2 on the reception-side includes a detection part 45 for each of the ports 44.

Note that the transmission-side transfer device 4b-2 does not need to include the detection part 45. Furthermore, even when the transmission-side transfer device 4b-2 includes the detection part 45 for each of the ports 44, the transmission-side transfer device 4b-2 does not need to use the detection part 45.

The communication device 2b performs packet processing using, for example, a data plane development kit. The communication device 2b-1 transmits a signal (packet) to the communication device 2b-2 for each of the ports 44-1. An operation of the transmission-side communication device 2b-1 (transmission device) is similar to the operation of the transmission-side communication device 2a-1 in the first embodiment.

Details of the reception-side communication device 2b-2 (reception device) will be explained below.

The detection part 45-2 detects whether a signal is input for each port 44-2. The detection part 45-2 outputs the detection result to the second transfer part 43-2.

The second transfer part 43-2 (combination processing part on the reception side) outputs information indicating the number of reception ports (port 44-2) in which signal input has been detected (hereinafter referred to as “third number information”) to the second header processing part 42b-2 on the basis of the detection results of each detection part 45-2. The second header processing part 42b-2 (header addition part on the reception side) adds header information to the frame. The header information includes third number information. The second header processing part 42b-2 records the frame to which header information has been added in the buffer 41-2. The buffer 41-2 outputs the frame to which the header information has been added to the communication part 34-2 through a communication process which is performed each time the communication part 34-2 performs interrupt processing or polling processing.

The communication part 34-2 (data reception part) acquires the frame to which header information has been added from the buffer 41-2 by performing communication processing every interrupt processing or polling processing. Note that, between the buffer 41-2 and the communication part 34-2, the communication processing load (amount of communication processing) performed for each interrupt processing or polling processing for frame delivery does not depend on the length of the reception data included in the frame.

The first header processing part 33b-2 (header analysis part on the reception side) analyzes header information added to the frame. The first header processing part 33b-2 acquires the second number information from the header information. The first header processing part 33b-2 outputs the second number information to the first transfer part 32-2. The first transfer part 32-2 (distribution processing part on the reception side) starts up the number of data processing parts 31-2 (threads) represented by the third number information. Thus, the number of data processing parts 31-2 represented by the third number information is generated. The first transfer part 32-2 transfers the reception data to the started-up data processing part 31-2.

The data processing part 31-2 performs predetermined data processing on the reception data transferred from the first transfer part 32-2. Here, the data processing part 31-2 may perform different data processing for each port 44.

As described above, the communication device 2b-2 (reception device) includes a detection part 45-2 for each port 44 (reception port). The detection part 45-2 detects whether an external signal is input for each port 44-2. The detection part 45-2 outputs the detection result to the second transfer part 43-2. Based on the detection result, the first transfer part 32-2 generates as many data processing parts 31-2 as ports 44-2 in which input of the external signal is detected. Note that the communication device 2b-1 (transmission device) does not need to include the detection part 45-1.

Thus, even when the number of signal ports 44 increases, it is possible to suppress an increase in communication processing load. In the communication system 1b, there are no plurality of communication parts 34-1 and there are no plurality of communication parts 34-2. Instead, a combination process and a distribution process with a small load are performed. For this reason, even when the number of signal ports 44 increases, it is possible to suppress an increase in communication processing load.

### Third Embodiment

The main difference between a third embodiment and the first and second embodiments is that a communication device is connected to a plurality of other communication devices using point-to-multipoint (P2MP). In the third embodiment, differences between the third embodiment and the first embodiment and the second embodiment will be mainly explained.

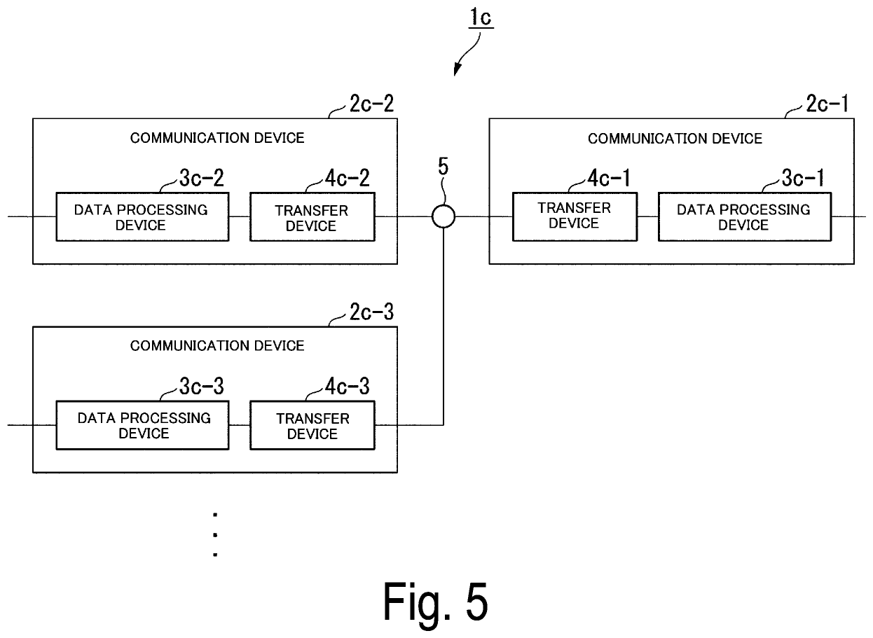

FIG. 5 is a diagram showing a configuration example of a communication system 1c in the third embodiment. The communication system 1c is, for example, a passive optical network (PON). The communication system 1c includes a transmission-side communication device 2c-1, a plurality of reception-side communication devices 2c, and a splitter 5.

In FIG. 5, the plurality of communication devices 2c on the reception side are, for example, a communication device 2c-2 and a communication device 2c-3. The communication device 2c is, for example, a server device. The splitter 5 is provided on an optical transmission path in the communication system 1c. The communication device 2c-1 on the transmission side is connected to a plurality of communication devices 2c on the reception side using point-to-multipoint.

The communication device 2c includes a data processing device 3c and a transfer device 4c. The data processing device 3c is, for example, a processor. The data processing device 3c may include hardware such as an accelerator. The transfer device 4c is a data transfer board (for example, a network interface card).

The communication device 2c performs packet processing using, for example, a data plane development kit. The communication device 2c-1 uses an optical signal to transmit a signal (packet) to the communication device 2c-n (n is an integer of 2 or more) for each transmission port. The splitter 5 transmits the optical signal transmitted from communication device 2c-1 to the communication device 2c-n.

As described above, the transmission-side communication device 2c-1 is connected to a plurality of reception-side communication devices 2c-n using point-to-multipoint (P2MP). Thus, even when the number of signal ports increases in a passive optical network (PON), it is possible to suppress an increase in communication processing load.

In the communication device of the communication system 1c, there are no plurality of communication parts 34-1 and there are no plurality of communication parts 34-2. Instead, a combination process and a distribution process with a small load are performed. Therefore, even when the number of signal ports 44 increases, it is possible to suppress an increase in communication processing load.

### Hardware Configuration

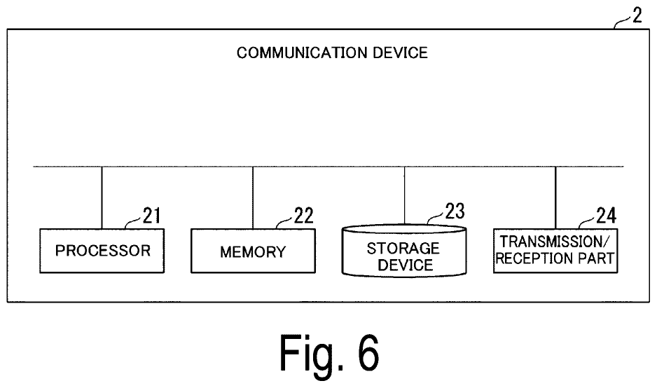

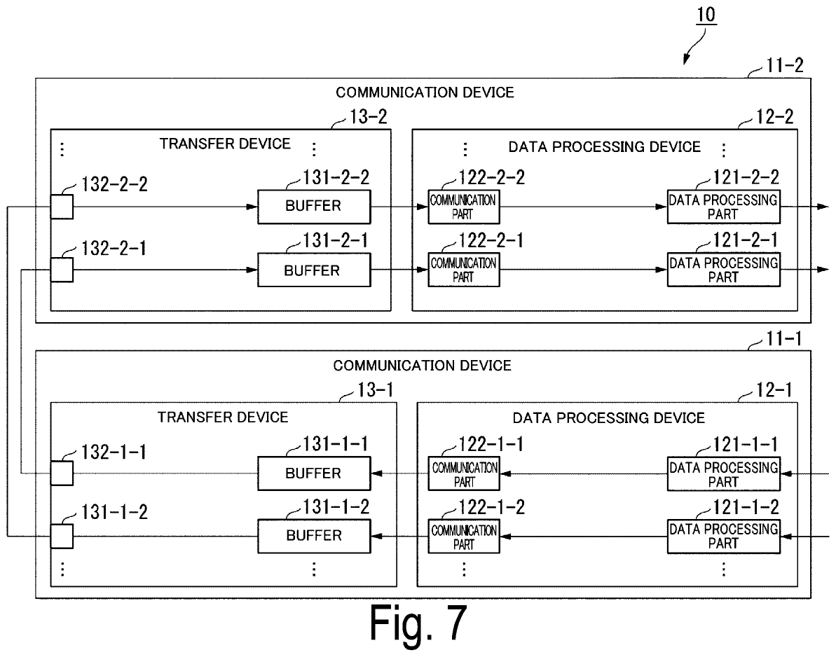

FIG. 6 is a diagram showing an example of a hardware configuration of the communication device 2 in each embodiment. The communication device 2 shown in FIG. 6 corresponds to the communication device 2a of the first embodiment, the communication device 2b of the second embodiment, and the communication device 2c of the third embodiment, respectively.

The communication device 2 is realized as software using a processor 21 such as a central processing unit (CPU) which performs a program stored in a storage device 23 having a non-volatile recording medium (non-temporary recording medium) and a memory 22. The program may be recorded on a computer-readable recording medium. The computer-readable recording medium is, for example, a portable medium such as a flexible disk, a magneto-optical disk, a read only memory (ROM), or a compact disc read only memory (CD-ROM), or a non-transitory storage medium such as a storage device such as a hard disk drive built into a computer system. The transmission/reception part 24 performs predetermined communication processing (transmission/reception processing).

The communication device 2 may be realized using, for example, hardware (accelerator) including electronic circuits (or circuitry) using a large scale integrated (LSI) circuit, an application specific integrated circuit (ASIC), a programmable logic device (PLD), a field programmable gate array (FPGA), or the like.

Although the embodiments of the present invention have been described above in detail with reference to the drawings, the specific configuration is not limited to these embodiments and includes designs within the scope of the gist of the present invention.

### INDUSTRIAL APPLICABILITY

The present invention is applicable to a communication system (access system) which includes a server device (data transfer device) and the like.

### REFERENCE SIGNS LIST

1a, 1b, 1c Communication system
2, 2a, 2b, 2c Communication device
3a, 3b, 3c Data processing device
4a, 4b, 4c Transfer device
5 Splitter
10 Communication system
11 Communication device
12 Data processing device
13 Transfer device
31 Data processing part
32 First transfer part
33a, 33b First header processing part
34 Communication part
41 Buffer
42a, 42b Second header processing part
43 Second transfer part
44 Port
45 Detection part
121 Data processing part
122 Communication part
131 Buffer
132 Port

1. A communication device, comprising:
a combination part which combines a plurality of pieces of transmission data;
a transmission part which transmits an internal signal based on the plurality of pieces of combined transmission data for each interrupt processing or polling processing; and
a distribution part which distributes an external signal based on the transmitted internal signal to a plurality of transmission ports.

2. A communication device, comprising:
a combination part which combines a plurality of external signals input to a plurality of reception ports;
a reception part which acquires an internal signal based on the plurality of combined external signals for each interrupt processing or polling processing; and
a distribution part which distributes a piece of reception data based on the acquired internal signal to a plurality of data processing parts.

3. A communication method performed by a communication device, comprising:
combining a plurality of pieces of transmission data;
transmitting an internal signal based on the plurality of pieces of combined transmission data for each interrupt processing or polling processing; and
distributing an external signal based on the transmitted internal signal to a plurality of transmission ports.

4-6. (canceled)
